(19) United States
(12) Patent Application Publication
(10) Pub. No.: US 2014/0094566 A1
(43) Pub. Date: Apr. 3, 2014

(54) Pavement Marking Composition System

(71) Applicants: James E. Garbe, Stillwater, MN (US); Craig A. Kapfer, Maplewood, MN (US)

(72) Inventors: James E. Garbe, Stillwater, MN (US); Craig A. Kapfer, Maplewood, MN (US)

(21) Appl. No.: 14/113,531

(22) PCT Filed: Jun. 21, 2012
(86) PCT No.: PCT/US12/43447

§ 371 Date: Oct. 23, 2013

Related U.S. Application Data
(60) Provisional application No. 61/500,288, filed on Jun. 23, 2011.

(51) Int. Cl. C09D 5/33

(52) U.S. Cl. CPC C09D 5/004
USPC 524/874

(57) ABSTRACT

A composition system includes a first portion having an isocyanate monomer and an acrylate monomer and a second portion includes a secondary amine monomer having at least two carbon atoms bonded to a nitrogen atom of the secondary amine monomer and at least one of the carbon atoms has two carbon atoms bonded to the carbon atom. The second portion includes a thermal acrylate polymerization initiator. The composition system can be utilized as pavement marking.

### BACKGROUND

There is a need for a liquid pavement marking composition that will provide increased durability and retained reflectivity once applied to a surface and dried or cured. Compositions of this type are used on roads, highways, parking lots, and recreational trails, to form stripes, bars and markings for the delineation of lanes, crosswalks, parking spaces, symbols, legends, and the like. They can be applied by spray coating (i.e., painting) the pavement surface.

Pavement marking stripes, or pavement markings of other shapes, may include reflective optical elements adhered to the pavement surface by the use of a binder. Current traffic paint systems can use glass microspheres for retroreflection. The microspheres can be flood coated onto the wet marking after coating. This provides the paint with improved retroreflectivity and also covers the top surface of the uncured or undried coating with a protective layer of microspheres. This protective layer can allow the markings to be exposed to traffic sooner because of the layer of microspheres over the surface, which prevents transfer of the coating to the surface of vehicle tires. The time between application and the point where material will no longer transfer to vehicle tires is defined as the “track-free” time. Shorter track-free times increase marking efficiency by reducing or eliminating the need for traffic disruption through such measures as closing lanes or placing traffic control devices to protect such markings.

It would be advantageous to apply markings in a wider range of weather conditions than is possible with existing compositions. There is also a need for marking compositions with improved cure profiles to ensure both substrate wet out and rapid track-free time. Furthermore, improvements are needed to obtain compositions that are substantially free of volatile organic components.

### BRIEF SUMMARY

The present disclosure relates to two-part thermally curable dual-cure coating compositions that can be utilized to mark movement surfaces. In particular, the present disclosure relates to a curable thermoset component (e.g., polyurea component) and a polymerizable acrylate component.

In one illustrative embodiment, a composition system includes a first portion having an isocyanate monomer and an acrylate monomer and a second portion includes a secondary amine monomer having at least two carbon atoms bonded to a nitrogen atom of the secondary amine monomer and at least one of the carbon atoms has two carbon atoms bonded to the carbon atom. The second portion includes a thermal acrylate polymerization initiator.

In another illustrative embodiment, a composition system includes a first portion having an isocyanate monomer and an acrylate monomer, and a second portion having an aspartic ester amine and a thermal acrylate polymerization initiator being a peroxide or an organoborane.

In a further illustrative embodiment, a method of marking a traffic bearing surface includes combining a first composition with a second composition to form a reactive mixture and applying the reactive mixture to a traffic bearing surface. The first composition having an isocyanate monomer and an acrylate monomer, and the second composition includes an aspartic ester amine and a thermal acrylate polymerization initiator.

These and various other features and advantages will be apparent from a reading of the following detailed description.

### DETAILED DESCRIPTION

The present disclosure describes two-part thermally curable dual-cure coating compositions that can be used to mark pavement surfaces, for example. These reactive compositions include a curable thermoset component (e.g., a polyurea component) and a polymerizable acrylate component. In many embodiments, the polymerization of the acrylate component can be initiated using a complex of an organoborane and an amine, this complex is surprisingly stable in certain components of the coating compositions. In other embodiments, the polymerization of the acrylate component can be initiated using a peroxide.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

As used in this specification and the appended claims, the singular forms “a”, “an”, and “the” encompass embodiments having plural referents, unless the content clearly dictates otherwise. As used in this specification and the appended claims, the term “or” is generally employed in its sense including “and/or” unless the content clearly dictates otherwise.

The present disclosure relates to two-part thermally curable dual-cure coating compositions that can be utilized to mark movement surfaces. In particular, the present disclosure relates to a curable thermoset component (e.g., polyurea component) and a polymerizable acrylate component. The thermally curable dual-cure coating compositions are two-part compositions. One part (“Part A”) includes an isocyanate that, when combined with an amine in the other part (“Part B”), forms a polyurea resin—a thermoset component. Part B can also include a polymerization initiator for an acrylate component, to thermally initiate polymerization of acrylate monomers, oligomers, or polymers in Part A—an acrylate component. Thus, Part B includes at least two compounds, one compound (an amine) to form the thermoset component, and one compound to thermally initiate polymerization of the acrylate component. Similarly, Part A includes at least two compounds, one compound to form the thermoset component by reaction with an amine, and one compound (an acrylate) that polymerizes when the initiator initiate polymerization. While the present disclosure is not so limited, an appreciation of various aspects of the disclosure will be gained through a discussion of the examples provided below.

The new thermally curable dual-cure coating compositions include a thermoset component and an acrylate component. The components independently polymerize to form a cured coating on a range of substrates, including pavement surfaces (i.e., traffic bearing surface). The thermoset component can polymerize to form, for example, a polyurea by the spontaneous reaction of an amine with an isocyanate. The acrylate component can polymerize to form an acrylic homopolymer or copolymer. The acrylic polymer can be crosslinked or not crosslinked. The thermoset and acrylic polymers in the coating can be chemically bonded to each other (by, for example, including in the composition a compound that is reactive with both the thermoset component and the acrylate component), or they can form an interpenetrating polymer network (IPN), where the components are not chemically bonded to each other.

In some embodiments, a composition system includes a first portion having an isocyanate monomer and an acrylate monomer and a second portion includes a secondary amine monomer having at least two carbon atoms bonded to a nitrogen atom of the secondary amine monomer and at least one of the carbon atoms has two carbon atoms bonded to the carbon atom. The second portion includes a thermal acrylate polymerization initiator. In another illustrative embodiment, a composition system includes a first portion having an isocyanate monomer and an acrylate monomer, and a second portion having an aspartic ester amine and a thermal acrylate polymerization initiator being a peroxide or an organoborane.

These thermally curable dual-cure coatings have an advantage over traditional polyurea, polyurethane, epoxy, or acrylate coatings, in that the two curable components provide a way to control or modify physical properties of the cured coating, such as hardness and flexibility, by controlling the chemistry of each component. The coatings have an advantage over alternative dual-cure coatings in which the polymerization of acrylate monomers is initiated by a photoinitiator, in that the type, color, and loading of pigments or fillers is not restricted by absorption or scattering of light of wavelengths necessary to initiate polymerization.

The thermoset component can include any thermoset component to form, for example, a polyurea, a polyurethane, or an epoxy. Thermoset systems can be two-part systems in which each part is kept separate from the other until just before the system is used, such as before a thermoset coating is applied to a substrate. Mixing the two parts results in a spontaneous chemical reaction (which can be catalyzed to increase the reaction rate) that forms a thermoset polymer or resin. In the cases of polyureas, polyurethanes, and epoxys, one of the parts includes a di- or polyamine.

The acrylate (e.g., (meth)acrylate) component can include any polymerizable acrylate or (meth)acrylate monomer, oligomer, or polymer. The acrylate component can include monofunctional acrylates and di- or polyfunctional acrylate. Polymerization of the acrylate component can be initiated by free radicals, which can be generated by the decomposition of free radical generators such as peroxides or hydroperoxides. Alternative free radical generators include complexes of organoboranes (such as trialkylboranes) and amines. The free radical generator can be kept separate from the acrylate component (i.e., in a separate part of the two-part system) until the parts are mixed before use.

Peroxide radical polymerization initiators can be any peroxide or hydroperoxide. If the peroxide has a relatively short decomposition half-life (e.g., less than about 6 months at about 50° C.), the peroxide can be added to the composition shortly before the composition is used. If the peroxide has a relatively long decomposition half-life, it can be added to the composition at any time, e.g., when the composition is manufactured. To control the rate of cure of the acrylate component, peroxide decomposition accelerators can be used. Such accelerators are known; examples include tertiary aromatic amines such as N,N-dimethylaniline.

Complexes of organoboranes and amines are formed by the reaction of an organoborane (a strong Lewis acid) and an amine (a strong Lewis base) Amines that form the most stable complexes (stable in the presence of oxygen) with organoboranes include primary amines and some secondary amines. Some tertiary amines, some sterically hindered primary and secondary amines, and amines in which the nitrogen atom lone electron pair is delocalized (and thus not available to form a strong dative bond with the boron atom empty p orbital) form less stable complexes with organoboranes. The complexes have the general structure

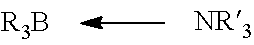

where each R can be an alkyl or cycloalkyl group, and each R′ can be H or an alkyl or cycloalkyl group. The borane-amine complexes are more stable than the free borane to oxidation by atmospheric oxygen, and can be stable for extended periods even in the presence of oxygen. The borane-amine complexes can be decomplexed, liberating free organoborane, by compounds that react with amines, such as isocyanates, carboxylic acids, carboxylic acid anhydrides. Free organoboranes react with oxygen to generate several free radical species, at least some of which can initiate radical polymerization of acrylates.

Some stable complexes of an organoborane and an amine, such as complexes of trialkylboranes and primary amines, remain surprisingly stable when combined with amines that form weak complexes with the organoborane Amines that form weak complexes with organoboranes include some tertiary amines, some sterically hindered primary amines, and amines in which the nitrogen atom lone electron pair is delocalized. This surprising stability allows storage of the mixtures for later use in thermally curable dual-cure coating compositions. These non-complexing amines are sterically hindered and provide improved control over cure rate of the thermoset components for pavement marking applications. In many embodiments the reactive mixtures described herein react at similar rates or have a “matched” cure rate. In some embodiments a small amount of material is extractable with organic solvents such as ketones following cure (e.g., less than 10 weight percent or less than 5 weight percent or less than 3 weight percent extractable material).

The thermally curable dual-cure coating compositions are two-part compositions. One part (“Part A”) includes an isocyanate that, when combined with an amine in the other part (“Part B”), forms a polyurea resin—a thermoset component. Part B can also include a polymerization initiator for an acrylate component, to thermally initiate polymerization of acrylate monomers, oligomers, or polymers in Part A—an acrylate component. Thus, Part B includes at least two compounds, one compound (an amine) to form the thermoset component, and one compound to thermally initiate polymerization of the acrylate component. Similarly, Part A includes at least two compounds, one compound to form the thermoset component by reaction with an amine, and one compound (an acrylate) that polymerizes when the initiator initiates polymerization.

The thermally curable dual-cure coating compositions can also include pigments, viscosity-modifying agents, diluents, and fillers. Pigments can include inorganic pigments such as oxides of titanium, zinc, chromium or iron; organic pigments such as azo pigments, diarylide pigments, naphthol pigments, phthalo pigments; and carbon black. Viscosity modifying agents can include liquids such as ketones, esters, and hydrocarbons; homopolymers or copolymers such as poly(styrene), poly(meth)acrylates such as poly(methyl methacrylate), and styrene-butadiene block copolymers; and silicas such as fumed silica and surface-modified fumed silica. Diluents can include liquids such as ketones, esters, and hydrocarbons. Fillers can include inorganic solids such as silica, zirconia and calcium carbonate.

To form the thermoset component or polyurea, an isocyanate is present in the first part and an amine is present in the second part of the composition system. In many embodiments the isocyanate includes a polyisocyanate and the amine includes an aspartic ester amine or a secondary amine monomer having at least two carbon atoms bonded to a nitrogen atom of the secondary amine monomer and at least one of the carbon atoms has two carbon atoms bonded to the carbon atom.

“Polyisocyanate” means any organic compound that has two or more reactive isocyanate (—NCO) groups in a single molecule such as diisocyanates, triisocyanates, tetraisocyanates, etc., and mixtures thereof. Polyisocyanate also includes oligomeric or polymeric isocyanates. Cyclic and/or linear polyisocyanate molecules may usefully be employed. For improved weathering and diminished yellowing, the polyisocyanate(s) of the isocyanate component is typically aliphatic. Useful aliphatic polyisocyanates include, for example, bis(4-isocyanatocyclohexyl) methane such as available from Bayer Corp., Pittsburgh, Pa. under the trade designation “Desmodur W”; isophorone diisocyanate (IPDI) such as commercially available from Huels America, Piscataway, N.J.; hexamethylene diisocyanate (HDI) such as commercially available from Aldrich Chemical Co., Milwaukee, Wis.; trimethyl hexamethylene diisocyanate such as commercially available from Degussa, Corp., Dusseldorf, Germany under the trade designation “Vestanate TMDI”; and m-tetramethylxylene diisocyanate (TMXDI) such as commercially available from Aldrich Chemical Co., Milwaukee, Wis. Although typically less preferred, aromatic isocyanates such as diphenylmethane diisocyanate (MDI) such as commercially available from Bayer Corp., Pittsburgh, Pa. under the trade designation “Mondur M”; toluene 2,4-diisocyanate (TDI) such as commercially available from Aldrich Chemical Co., Milwaukee, Wis., and 1,4-phenylene diisocyanate are also useful. In many embodiments, the polyisocyanates include derivatives of the above-listed monomeric polyisocyanates. These derivatives include, but are not limited to, polyisocyanates containing biuret groups, such as the biuret adduct of hexamethylene diisocyanate (HDI) available from Bayer Corp. under the trade designation “Desmodur N-100”, polyisocyanates containing isocyanurate groups, such as that available from Bayer Corp. under trade designation “Desmodur N-3300” or Desmodur XP2410, as well as polyisocyanates containing urethane groups, uretdione groups, carbodiimide groups, allophonate groups, and the like.

The amine includes an aspartic ester amine or a secondary amine monomer having at least two carbon atoms bonded to a nitrogen atom of the secondary amine monomer and at least one of the carbon atoms has two carbon atoms bonded to the carbon atom. The amine can include at least one polyamine As used herein “polyamine” refers to compounds having at least two amine groups each containing at least one active hydrogen (N—H group) selected from primary amine or secondary amine Polyamine also includes oligomeric or polymeric amines The amine component can include aliphatic and/or aromatic polyamine(s). For improved weathering and diminished yellowing, the amine component is typically aliphatic. In order to obtain the preferred reaction rate, the amine component includes and may consist solely of one or more secondary amines In many embodiments the secondary amines are sterically hindered amines.

A secondary sterically hindered amine is defined structurally as a secondary amine in which the amino group is attached to a secondary or a tertiary carbon atom. Secondary amines can include an aspartic ester amine. The aspartic ester amine can include a compound of formula:

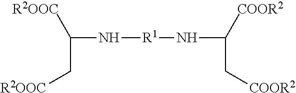

wherein R¹ is a divalent organic group having from 1 to 40 carbon atoms and R² is independently an organic group having from 1 to 40 carbon atoms or from 1 to 8 carbon atoms or from 1 to 4 carbon atoms. In some embodiments the aspartic ester amine includes a compound of formula:

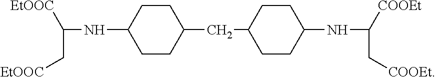 [SMILES: CCOC(=O)CC(NC1CCC(CC2CCC(NC(CC(=O)OCC)C(=O)OCC)CC2)CC1)C(=O)OCC]

In other embodiments, the aspartic ester amine includes a compound of formula:

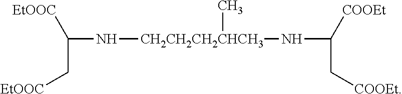

In some embodiments one or more amine-functional coreactants can be added to the aspartic ester amines.

These amines (other than aspartic ester amines) can function as chain extenders and/or impact modifiers. The use of such amine-functional coreactant(s) can contribute to the presence of soft segments in the polymer backbone for improved toughness properties. Such amine-functional coreactants can be primary amines, secondary amines, or combinations thereof. In some embodiments, the amine-functional coreactant is an aliphatic diamine such as commercially available from Dorf Ketal Chemicals LLC, Stafford, Tex., under the trade designation “Clearlink 1000”.

The acrylate component is formed by combining the acrylate monomer in the first part with the thermal acrylate polymerization initiator in the second part. As described above, it has been found that particular thermal acrylate polymerization initiators are surprising stable with the amine in the second part of the composition system. In many embodiments the thermal acrylate polymerization initiators includes peroxides or an organoborane.

The organoborane can include an organoborane and amine complex. Examples of organoborane and amine complex include triethylborane and 1,3-propanediamine complex, and tri-n-butylborane and 3-methoxypropylamine complex.

The acrylate monomer can be any useful monomer having acrylate functionality. Acrylate-functional compounds include any ester of acrylic acid and methacrylic acid, such as alkyl and cycloalkyl (meth)acrylates. Examples of such compounds include methyl acrylate, methyl methacrylate, n-butyl acrylate, n-butyl methacrylate, isobutyl acrylate, isobutyl methacrylate, tert-butyl acrylate, tert-butyl methacrylate, 2-ethylhexyl acrylate, 2-ethylhexyl methacrylate, cyclohexylmethyl acrylate, cyclohexylmethyl methacrylate, n-octyl acrylate, n-ocyl methacrylate, iso-octyl acrylate, isooctyl methacrylate, isobornyl acrylate, and isobornyl methacrylate. Acrylate-functional compounds also include oligomeric or polymermic (meth)acrylates, including macromonomers comprising poly(styrene), poly(dimethylsiloxane), and poly(methyl methacrylate). Acrylate-functional compounds also include all those described herein below, in connection with urethane acrylates and acrylate-functional polyisocyanates. Suitable acrylate-functional compounds can also have epoxy groups, an example of which is glycidyl(meth)acrylate, or the reaction products of equimolar amounts of acrylic or methacrylic acid and diepoxide compounds, such as, for example, neopentylglycol diglycidyl ester. Reaction products of hydroxyl-containing, polymerizable monomers, such as, for example, hydroxyethyl acrylate, and diepoxides are also suitable. In some embodiments the acrylate-containing compound is hexane diol diacrylate, sold under the trade name Sartomer SR238 or a mixture of acrylic acid esters of pentaerythritol sold under the trade name Sartomer SR295 from Sartomer USA, LLC. In some embodiments the acrylate-containing compound is a triacrylate sold under the trade designation Desmolux XP2513 or a urethane acrylate sold under the trade designation Desmolux U680H or a compound having both isocyanate and acrylate groups sold under the trade designation Desmolux D100 all from Bayer MaterialScience LLC, Pittsburgh, Pa. Other useful acrylate-containing compounds include Ebecryl 280/15IB (a urethane diacrylate/isobornyl acrylate mixture) or Ebecryl 893 (a modified polyester acrylate) or Ebecryl 10601 (a modified epoxy acrylate) all obtained from Cytec Industries, Inc., Woodland Park, N.J.

The two-part composition systems described herein can be combined to form a reactive mixtures and applied to a traffic bearing surface to form a pavement marking. The pavement marking exhibits good adhesion to a wide variety of substrates and surfaces, including concrete and asphalt. Track-free time of the pavement marking is the time after the marking is applied before cars can drive on the marking without picking up and tracking the applied marking. The track-free time can be measured in the laboratory using ASTM D 711-89 or in the field using ASTM D713-90. The pavement marking has a track free time according to ASTM D 711-89 of no greater than about 60 minutes, no greater than about 30 minutes, no greater than about 15 minutes, no greater than about 4-10 minutes, or no greater than about 5 minutes. Further, the reactive mixture once applied to a traffic bearing surface has a sufficient open time (i.e., the length of time the composition will remain in a liquid state after application to a surface) to adequately wet out to the surface being applied to in combination with good anchoring of the reflective elements.

In many embodiments, the reflective elements are retroreflective elements which are microcrystalline microspheres. The microcrystalline microspheres may be non-vitreous, such as described in U.S. Pat. No. 4,564,556 (Lange) or the microspheres may comprise a glass-ceramic material, such as described in U.S. Pat. No. 6,461,988, also incorporated herein by reference. The retroreflective elements can have a refractive index of about 1.5 to about 2.6 and can have a diameter in a range from 30 to 100 micrometers. The approximate open time can be assessed using one of the tests in ASTM D1640-95. Alternatively, it can be determined by spraying a coating and applying reflective elements and determining the maximum time after spraying that the beads can be applied and good bead sinking and adhesion can be obtained. The pavement marking can have an open time as measured according to ASTM D1640-95 of at least about 30 seconds, or at least about 1 minute.

For embodiments wherein the marking is intended to provide nighttime visibility, the reactive mixture exhibits good adhesion to the retroreflective elements. Good adhesion to surface being applied to in combination with good adhesion to the retroreflective elements contribute to the retained retroreflectivity of the pavement marking. As used herein, “retained reflectivity” is used to describe the maintained retroreflective performance of a pavement marker over its useful life. Retroreflectivity of pavement markings is typically measured by a portable instrument in the field at a fixed entrance angle and observation angle according to ASTM E 1710-95a that approximates the conditions a driver actually views a pavement marking.

Pavements markings are often used to define lanes and therefore applied as continuous lines on the edge of a lane or in dashed lines separating lanes, referred to as skips. Such markings are referred to as longitudinal markings in that the lines run parallel to the direction of travel. In actual use a relatively small percent of vehicles using the road will actually traverse these markings. Alternatively, pavement markings are also used to mark intersections in the form of stopbars, continental blocks, or symbols and legends. In actual use, a relatively large percent of vehicles using the road will actually traverse such markings, or portions of such markings.

### EXAMPLES

Unless otherwise noted, chemicals were or can be obtained from Sigma Aldrich Co., Milwaukee, Wis.

Thermally curable multi-component coating compositions were made according to Tables 1 and 2. The amount of each component was calculated to provide compositions comprising Parts A and B in a 2 to 1 volume ratio. In Tables 1 and 2, “n/a” means that that the exemplary composition did not include the corresponding component.

TEB-DAP refers to a complex of triethylborane and 1,3-propanediamine, obtained from BASF Corp., Evans City, Pa.

TNBB-MOPA refers to a complex of tri-n-butylborane and 3-methoxypropylamine, obtained from BASF Corp., Evans City, Pa.

Desmophen NH 1420 refers to a cycloaliphatic aspartic ester diamine obtained from Bayer MaterialScience LLC, Pittsburgh, Pa.

Desmophen NH 1220 refers to an aliphatic aspartic ester diamine obtained from Bayer MaterialScience LLC, Pittsburgh, Pa.

Clearlink 1000 refers to a cycloaliphatic diamine obtained from Dorf Ketal Chemicals LLC, Stafford, Tex.

TI-Pure R960 refers to powdered titanium dioxide, obtained from DuPont Titanium Technologies, Wilmington, Del.

Desmolux XP2513 refers to a triacrylate obtained from Bayer MaterialScience LLC, Pittsburgh, Pa.

Desmolux U680H refers to a urethane acrylate obtained from Bayer MaterialScience LLC, Pittsburgh, Pa.

Desmolux D100 refers to a compound having both isocyanate and acrylate groups obtained from Bayer MaterialScience LLC, Pittsburgh, Pa.

Desmodur XP2410 refers to a polyisocyanate obtained from Bayer MaterialScience LLC, Pittsburgh, Pa.

Desmodur N100 refers to a polyisocyanate obtained from Bayer MaterialScience LLC, Pittsburgh, Pa.

Desmodur N3300 refers to a polyisocyanate obtained from Bayer MaterialScience LLC, Pittsburgh, Pa.

SR238 refers to hexanediol diacrylate, obtained from Sartomer USA, LLC, Exton, Pa.

SR295 refers to a mixture of acrylic acid esters of pentaerythritol, obtained from Sartomer USA, LLC.

Ebecryl 280/15IB refers to a urethane diacrylate/isobornyl acrylate mixture obtained from Cytec Industries, Inc., Woodland Park, N.J.

Ebecryl 893 refers to a modified polyester acrylate obtained from Cytec Industries, Inc., Woodland Park, N.J.

Ebecryl 10601 refers to a modified epoxy acrylate obtained from Cytec Industries, Inc., Woodland Park, N.J.

Omyacarb 6 refers to powdered calcium carbonate, available from Omya Inc., Cincinnati, Ohio.

S6OHS refers to glass microspheres having a mean diameter of about 60 micrometers, available from 3M Company, St. Paul, Minn.

BPO refers to a 50 weight percent mixture of benzoyl peroxide and tricresyl phosphate.

NNDA refers to N,N-dimethylaniline.

NNDT refers to N,N-dimethyl-p-toluidine.

MEKPO refers to a 50 weight percent mixture of methyl ethyl ketone peroxide and phthalic acid ester, obtained from Pfaltz & Bauer, Waterbury, Conn.

“DTBPO” refers to di-tert-butyl peroxide, obtained from TCI America, Portland, Oreg.

“UOP-L” refers to a moisture adsorbing powder obtained from UOP LLC, Des Plaines, Ill.

“S-Wax” refers to a paraffin wax obtained from Sasolwax North America, Richmond, Calif.

“Lansco 2283” refers to a Yellow 83 pigment obtained from Lansco Colors, Pearl River, N.Y.

### EXAMPLES 1-6

Each of the compositions of Examples 1-6, listed in Table 1, comprised an organoborane-amine complex.

For each of Examples 1-6, each Part A was prepared by combining the components in a beaker, and then stirring the mixture using a spatula. Each mixture was then stirred using a spatula. Each Part B was prepared by first dispersing the Ti-Pure R960 in Desmophen N.H. 1420 using a Cowles-type dispersing mixer, and then adding TEB-DAP. For Examples 2 and 6, Clearlink 1000 was then added. Each Part A and the corresponding Part B were loaded into 2:1 dispensing cartridges, with Part A in the 2 volume part chamber, and Part B in the 1 volume part chamber. Using a dispensing gun, each cartridge was partially discharged into a beaker, and the two parts A and B were then vigorously stirred for 30 to 45 seconds using a spatula. Each mixture was then coated onto white paper release liner using a 0.020″ notched coating bar. Each coating was evaluated by the time it took for each coating to cure enough to be easily peeled by hand from the release liner. Each of the coatings could be peeled from the release liner within 60 minutes after coating.

TABLE 1
Compositions of Examples 1-6

| Component | Ex 1 | Ex 2 | Ex 3 | Ex 4 | Ex 5 | Ex 6 |
|---|---|---|---|---|---|---|
| Part A | | | | | | |
| Desmolux | 36.0 gm | 36.0 gm | 41.5 gm | 12.0 gm | 13.5 gm | 20.0 gm |
| XP2513 | | | | | | |
| Desmolux | 30.0 gm | 29.0 gm | 30.0 gm | 41.0 gm | 3.5 gm | 18.0 gm |
| D100 | | | | | | |
| Desmodur | 22.0 gm | 22.0 gm | 22.0 gm | 16.5 gm | 36.0 gm | 16.0 gm |
| XP2410 | | | | | | |
| SR238 | 10.0 gm | 10.0 gm | 5.0 gm | 5.0 gm | 4.0 gm | 5.0 gm |
| Ebecryl | 10.0 gm | 10.0 gm | 10.0 gm | 14.0 gm | 29.0 gm | 17.0 gm |
| 280/15IB | | | | | | |
| Omayacarb 6 | n/a | n/a | n/a | 10.0 gm | n/a | 9.5 gm |
| S60HS | n/a | n/a | n/a | 8.0 gm | n/a | n/a |
| Isobornyl | n/a | n/a | n/a | n/a | 13.5 gm | n/a |
| acrylate | | | | | | |
| 2-ethylhexyl | n/a | n/a | n/a | n/a | 6.0 gm | n/a |
| acrylate | | | | | | |
| Part B | | | | | | |
| TEB-DAP | 5.0 gm | 3.7 gm | 5.0 gm | 6.5 gm | 5.0 gm | n/a |
| TNBB-MOPA | n/a | n/a | n/a | n/a | n/a | 6.0 gm |
| Desmophen | 39.0 gm | 33.0 gm | 39.0 gm | 37.0 gm | 39.0 gm | 20.0 gm |
| NH 1420 | | | | | | |
| Clearlink 1000 | n/a | 6.0 gm | n/a | n/a | n/a | 5.5 gm |
| Ti-Pure R960 | 22.0 gm | 22.0 gm | 22.0 gm | 22.0 | 22.0 gm | 15 gm |

### EXAMPLES 7-12

Each of the compositions of Examples 7-12, listed in Table 2, comprised an organic peroxide. For each of Examples 7-14, each Part A was prepared by combining the components in a beaker, and then stirring the mixture using a spatula. Each mixture was then stirred using a spatula. Each Part B was similarly prepared. Each Part A and the corresponding Part B were separately weighed into beakers, at a weight ratio that provided a volume ratio of 2 volume parts A and 1 volume part B, and the contents of the beakers were combined in another beaker. After each mixture was rapidly stirred by hand, it was then coated onto white paper release liner using a 0.025″ notched coating bar. Each coating was evaluated by the time it took for each coating to cure enough to be easily peeled by hand from the release liner. Each of the coatings could be peeled from the release liner within 60 minutes after coating.

TABLE 2
Compositions of Examples 7-12.

| Component | Ex 7 | Ex 8 | Ex 9 | Ex 10 | Ex 11 | Ex 12 |
|---|---|---|---|---|---|---|
| Part A | | | | | | |
| Desmolux XP2513 | 11.28 gm | 13.58 gm | 13.58 gm | 28.97 gm | 10.39 gm | 24.98 gm |
| Desmolux D100 | 3.02 gm | 8.03 gm | 5.50 gm | 5.50 gm | 11.33 gm | 5.50 gm |
| Desmolux U680H | n/a | 11.60 gm | 14.15 gm | 20.59 gm | 9.71 gm | 14.15 gm |
| SR238 | 3.36 gm | 11.22 gm | 11.22 gm | 5.10 gm | 7.14 gm | 13.57 gm |
| SR295 | n/a | 11.09 gm | 11.09 gm | n/a | 8.37 gm | n/a |
| Desmodur N100 | 20.06 gm | 17.10 gm | 17.10 gm | 12.20 gm | n/a | 14.48 gm |
| Desmodur N3300 | n/a | n/a | n/a | n/a | 14.14 gm | n/a |
| Omayacarb 6 | n/a | n/a | n/a | n/a | 18.97 gm | n/a |
| UOP-L | n/a | n/a | n/a | n/a | 5.39 gm | n/a |
| Ebecryl 893 | 24.62 gm | n/a | n/a | n/a | n/a | n/a |
| Ebecryl LEO 10601 | 9.06 gm | n/a | n/a | n/a | n/a | n/a |
| S-Wax | 0.90 gm | n/a | n/a | n/a | n/a | n/a |
| NNDA | 1.91 gm | 0.96 gm | 0.96 | 1.91 gm | n/a | 0.96 gm |
| NNDT | n/a | n/a | n/a | n/a | 1.87 gm | n/a |
| Part B | | | | | | |
| MEKPO | 1.00 gm | n/a | n/a | n/a | n/a | n/a |
| BPO | n/a | n/a | 5.80 gm | 5.80 gm | n/a | n/a |
| DTBPO | n/a | 2.39 gm | n/a | n/a | n/a | n/a |
| Desmophen NH 1420 | 28.97 gm | 28.97 gm | 26.85 gm | 20.49 gm | 16.05 gm | 23.47 gm |
| Desmophen NH 1220 | n/a | n/a | n/a | 5.33 gm | n/a | n/a |
| Clearlink 1000 | n/a | n/a | n/a | n/a | 4.45 gm | |
| Ti-Pure R960 | 19.50 gm | 11.70 gm | 11.70 gm | 15.60 gm | 5.08 gm | 5.08 gm |
| Lansco 2283 | n/a | n/a | n/a | n/a | 7.04 gm | 7.04 gm |

### EXAMPLE 13

A portion of the cured coating of Example 4 was extracted with methyl ethyl ketone in a Soxhlet extractor to determine the weight percentage of extractable materials in the portion. A weighed sample of the cured coating of Example 4 (0.523 gm) was placed in a cellulose thimble which was then placed in a Soxhlet extraction apparatus. The sample was extracted with methyl ethyl ketone for 3.5 hours, after which time the extracted sample was removed from the thimble. Residual solvent was removed from the sample by drying the sample in a forced air oven at a temperature of 60° C. (140° F.) for 2 hours. The weight of the extracted and dried sample was determined to be 0.505 gm. Thus, 0.018 gm (3.4 weight percent) of the sample of cured coating was extractable materials.

Thus, embodiments of the PAVEMENT MARKING COMPOSITION SYSTEM are disclosed. The implementations described above and other implementations are within the scope of the following claims. One skilled in the art will appreciate that the present disclosure can be practiced with embodiments other than those disclosed. The disclosed embodiments are presented for purposes of illustration and not limitation, and the present disclosure is limited only by the claims that follow.

1. A composition system comprising:
a first portion comprising:
an isocyanate monomer; and
an acrylate monomer;
a second portion comprising:
a secondary amine monomer having at least two carbon atoms bonded to a nitrogen atom of the secondary amine monomer and at least one of the carbon atoms has two carbon atoms bonded to the carbon atom; and
a thermal acrylate polymerization initiator.

2. The composition system of claim 1 wherein the thermal acrylate polymerization initiator comprises an organoborane.

3. The composition system of claim 1 wherein the thermal acrylate polymerization initiator comprises an organoborane and amine complex.

4. The composition system of claim 3 wherein the first portion further includes a monomer having acrylate and isocyanate groups.

5. The composition system of claim 1 wherein the thermal acrylate polymerization initiator comprises an triethylborane and 1,3-propanediamine complex.

6. The composition system of claim 1 wherein the thermal acrylate polymerization initiator comprises an tri-n-butylborane and 3-methoxypropylamine complex.

7. The composition system of claim 1 wherein the thermal acrylate polymerization initiator comprises a peroxide.

8. The composition system of claim 1 wherein the secondary amine monomer comprises an aspartic ester amine.

9. The composition system of any of claim 1 wherein the secondary amine monomer comprises a compound of formula:

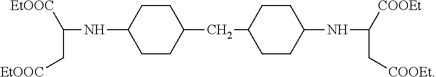 [SMILES: CCOC(=O)CC(NC1CCC(CC2CCC(NC(CC(=O)OCC)C(=O)OCC)CC2)CC1)C(=O)OCC]

10. The composition system of claim 1 wherein the secondary amine monomer comprises a compound of formula:

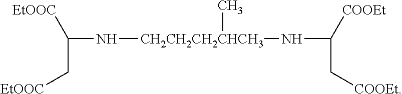

11. A composition system comprising:
a first portion comprising:
an isocyanate monomer; and
an acrylate monomer;
a second portion comprising:
an aspartic ester amine; and
a thermal acrylate polymerization initiator comprising a peroxide or an organoborane.

12. The composition system of claim 11 wherein the aspartic ester amine comprises a compound of formula: 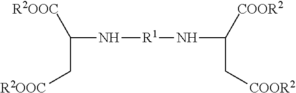
wherein R¹ is a divalent organic group having from 1 to 40 carbon atoms and R² is independently an organic group having from 1 to 8 carbon atoms.

13. The composition system of claim 11 wherein the aspartic ester amine comprises a compound of formula:

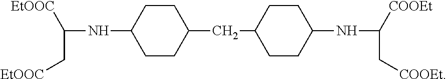 [SMILES: CCOC(=O)CC(NC1CCC(CC2CCC(NC(CC(=O)OCC)C(=O)OCC)CC2)CC1)C(=O)OCC]

14. The composition system of claim 11 wherein the aspartic ester amine comprises a compound of formula:

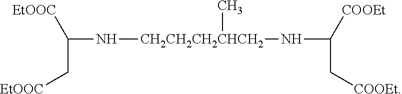

15. The composition system of claim 11 wherein the wherein the thermal acrylate polymerization initiator comprises a pyrophoric organoborane and amine complex.

16. The composition system of claim 15 wherein the organoborane and amine complex comprises an triethylborane and 1,3-propanediamine complex.

17. The composition system of claim 15 wherein the organoborane and amine complex comprises an tri-n-butylborane and 3-methoxypropylamine complex.

18. A method of marking a traffic bearing surface comprising:
combining a first composition with a second composition to form a reactive mixture, the first composition comprising:
an isocyanate monomer; and
an acrylate monomer;
the second composition comprising:
an aspartic ester amine; and
a thermal acrylate polymerization initiator; and
applying the reactive mixture to a traffic bearing surface.

19. The method of claim 18 further comprising applying reflective elements to the reactive mixture.

20. The method of claim 18 wherein the thermal acrylate polymerization initiator comprises a organoborane and amine complex and the aspartic ester amine comprises a compound of formula: 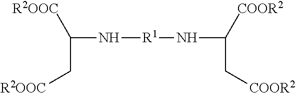
wherein R¹ is a divalent organic group having from 1 to 40 carbon atoms and R² is independently an organic group having from 1 to 8 carbon atoms.
